(19) United States
(12) Patent Application Publication
(10) Pub. No.: US 2017/0068714 A1
(43) Pub. Date: Mar. 9, 2017

(54) GENERATING MULTIPLE FLAT FILES FROM A HIERARCHAL STRUCTURE

(71) Applicant: TMM Data, LLC, Philipsburg, PA (US)

(72) Inventors: Robert L. Selfridge, Philipsburg, PA (US); Charles Crumrine, Morrisdale, PA (US)

(21) Appl. No.: 15/120,468

(22) PCT Filed: Aug. 29, 2014
(86) PCT No.: PCT/US14/53368

§ 371 Date: Aug. 19, 2016

Related U.S. Application Data
(60) Provisional application No. 61/992,766, filed on May 13, 2014.

(51) Int. Cl. G06F 17/30

(52) U.S. Cl. CPC G06F 17/30569; G06F 17/30312; G06F 17/30595; G06F 17/30477

(57) ABSTRACT

A computerized method for automatically converting hierarchical data to a flat database table can comprise receiving a hierarchical data set comprising one or more nodes. The method can also comprise identifying at least one node comprising at least one data field. The method can then comprise distilling the at least one node to one or more independent data fields, wherein each of the one or more independent data fields comprise more than a single data entry. The method can further comprise automatically generating one or more flat data tables to store data entries form the one or more independent data fields. Further still, the method can comprise constructing a relational database of the one or more flat data tables and storing the relational database.

### BACKGROUND OF THE INVENTION

Technical Field

The present invention relates generally to data collection, management, and sharing.

Background and Relevant Art

Data collection, management, and sharing are ubiquitous in our society and in the information age. Many individuals and organizations create, consume, and maintain vast quantities of data—they have data in spreadsheets, textual documents, databases, enterprise systems, third-party systems, etc. As such, individuals and organizations face the challenge of sharing data across platforms and maintaining datasets.

For example, many individuals and organizations use relatively simple tools such as text documents, spreadsheets, and email to manually enter, organize, store, and share datasets. Using manual means to enter and maintain data is subject to human error and inconsistency. As an unintended consequence, datasets can become disjointed and error-prone as human interaction with the datasets increase in number and iteration.

Referring specifically to data entry, for example, data entry by humans is prone to causing data discrepancies. Different front-end client users—or even the same client user from one data entry to the next—may provide discrepant data. Data discrepancies may result from various expressions of the same piece of information. For example, United States of America, United States, U.S.A., and U.S. are all commonly used terms identifying the same country. Furthermore, different users may interpret the type of data that is requested or required by a particular data field in different ways. Discrepancies like the foregoing complicate the process of standardizing, managing, and sharing data.

Referring to database management, multiple users providing different information related to the same data entity often complicates the integration and standardization of the data, making it difficult to retrieve and share the data. In addition, multiple users providing different information related to the same data entity often makes it difficult and burdensome to provide a data set that is consistent and non-redundant.

Additionally, in some cases it may be desirable to import data from a variety of sources into a master database. The data to be imported may comprise previously organized data, previously indexed data, unstructured data, or hierarchical data. Each of these data types may require particular systems and methods for importation into the master database. This is particularly the case when the data is provided from disparate sources, each of which may utilize different field constraints.

Hierarchical data sources, in particular, present many challenges. For example, hierarchical data may be organized in a wide number of stratified layers and complexities and comprise multiple entries for any given data field. Additionally, the actual number of entries per data field may vary across all data fields of the same type. The structural inconsistencies between data fields that may arise within hierarchical data sources make storing hierarchical data types problematic with conventional methods. For example, some conventional methods of storing hierarchical data result in numerous repeated entries, culminating in a substantial amount of wasted space.

Accordingly, there are a number of disadvantages in the art of data collection and management that can be addressed.

### BRIEF SUMMARY

Implementations of the present invention comprise systems, methods, and apparatus configured to convert hierarchical data into multiple flat files. In particular, implementations of the present invention comprise methods and systems for analyzing a data file that contains one or more fields of hierarchical data. The methods and systems can further comprise extracting the data from the fields and placing the data within multiple flat data tables. The multiple flat data tables can then be efficiently stored and accessed for later database functions.

For example, an implementation of a computerized method for automatically converting hierarchical data to a flat database table can comprise receiving a hierarchical data set comprising one or more nodes. The method can also comprise identifying at least one node comprising at least one data field. In addition, the method can comprise distilling the at least one node to one or more independent data fields, wherein each of the one or more independent data fields comprise more than a single data entry. The method can further comprise automatically generating one or more flat data tables to store data entries form the one or more independent data fields. Further still, the method can comprise constructing a relational database of the one or more flat data tables and storing the relational database.

The method can also comprise identifying at least one data field within the hierarchical nodes that comprises more than a single data entry. In addition, the method comprises, upon identifying a data field with more than a single entry, generating a second flat data table. The second flat data table can comprise information stored within the at least one data field. Further, the method can comprise identifying other data fields within the hierarchical nodes that comprise data entries that are compatible with the second flat data table or constructing new flat data tables, as necessary, that are compatible with the data entries in the other data fields. Further still, the method can comprise inserting information stored within the other data fields into the second flat data table.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic representation of a system for converting hierarchical data to flat files in accordance with an implementation of the present invention;

FIG. 2 illustrates a method of distilling a representative hierarchical data set to associated flat files in accordance with an implementation of the present invention;

FIG. 3 depicts an implementation of hierarchical data used in accordance with an implementation of the present invention;

FIG. 4A depicts a flat files created from the hierarchical data of FIG. 3;

FIG. 4B depicts another flat files created from the hierarchical data of FIG. 3;

FIG. 4C depicts another flat files created from the hierarchical data of FIG. 3;

FIG. 4D depicts another flat files created from the hierarchical data of FIG. 3;

FIG. 4E depicts another flat files created from the hierarchical data of FIG. 3;

FIG. 4F depicts another flat files created from the hierarchical data of FIG. 3;

FIG. 4G depicts another flat files created from the hierarchical data of FIG. 3;

FIG. 5 depicts a database table constructed from the multiple flat files from FIGS. 4A-4G;

FIG. 6 depicts a flowchart of a method for creating multiple flat files from a hierarchical data set in accordance with an implementation of the present invention; and

FIG. 7 depicts a flowchart of a method for creating multiple flat files from a hierarchical data based on a user query in accordance with an implementation of the present invention.

### DETAILED DESCRIPTION OF THE PREFERRED EMBODIMENTS

Implementations of the present invention extend to systems, methods, and apparatus configured to convert hierarchical data into multiple flat files. In particular, implementations of the present invention comprise methods and systems for analyzing a data file that contains one or more fields of hierarchical data. The methods and systems can further comprise extracting the data from the fields and placing the data within multiple flat data tables. The multiple flat data tables can then be efficiently stored and accessed for later database functions.

Accordingly, implementations of the present invention provide a method to automatically convert hierarchical data into flat data tables, which can be more easily analyzed or processed within database systems. Further, complex hierarchical data structures can contain a series of stacked nodes and clusters of information that can contain a variable number of data entries within each node, making it difficult to compare or analyze two related nodes. In one implementation, the methods described within the present invention make it possible to more easily compare information within related nodes when viewed in a flat table format. One will appreciate in view of the following specification and claims that converting hierarchical data to flat files increases the ease by which this information can be utilized and incorporated by existing software and technologies. Additionally, in at least one implementation, storing the multiple flat data tables may consume significantly less memory than storing the equivalent information within a single flat table. As such, implementations of the present invention provide several benefits when dealing with hierarchical data.

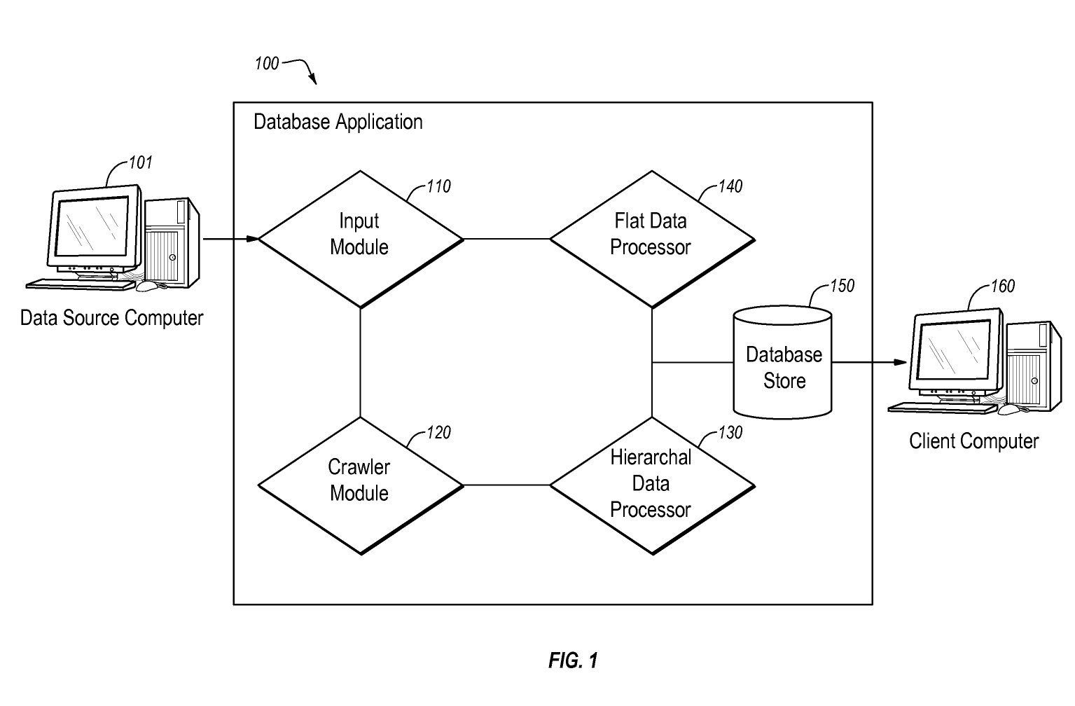

For example, FIG. 1 depicts a schematic of a system for converting hierarchical data into multiple flat data tables. In particular, FIG. 1 depicts a data source computer 101 in communication with a database application 100 of the present invention. The data source computer 101 may represent a variety of different data sources, such as servers on the Internet, private customer servers, and any other available data source.

FIG. 1 shows that the data source computer 101 communicates with an input module 110 of the database application 100. The input module 110, in turn, receives various information types from the data source computer 101. For example, the input module 110 may receive previously organized database files, previously indexed files, arrays, or other similar flat file types. FIG. 1 further shows that, upon receiving these flat file types, the input module 110 can provide these file types to the flat data processor 140. In one implementation, the flat data processor 140 can be configured to analyze the received file types and prepare them for the database store 150 such that they are properly configured for access by client computers 160.

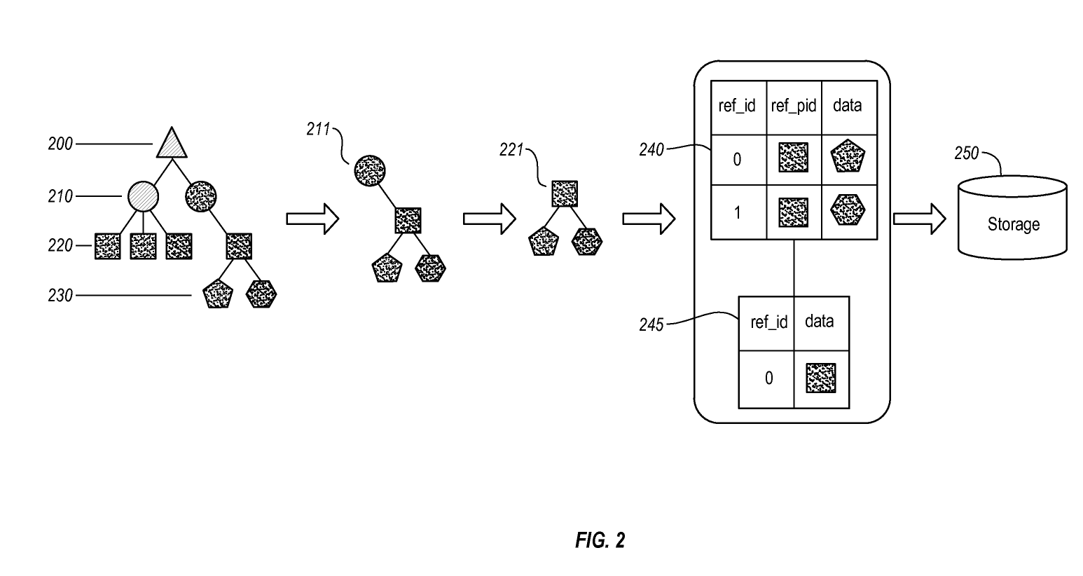

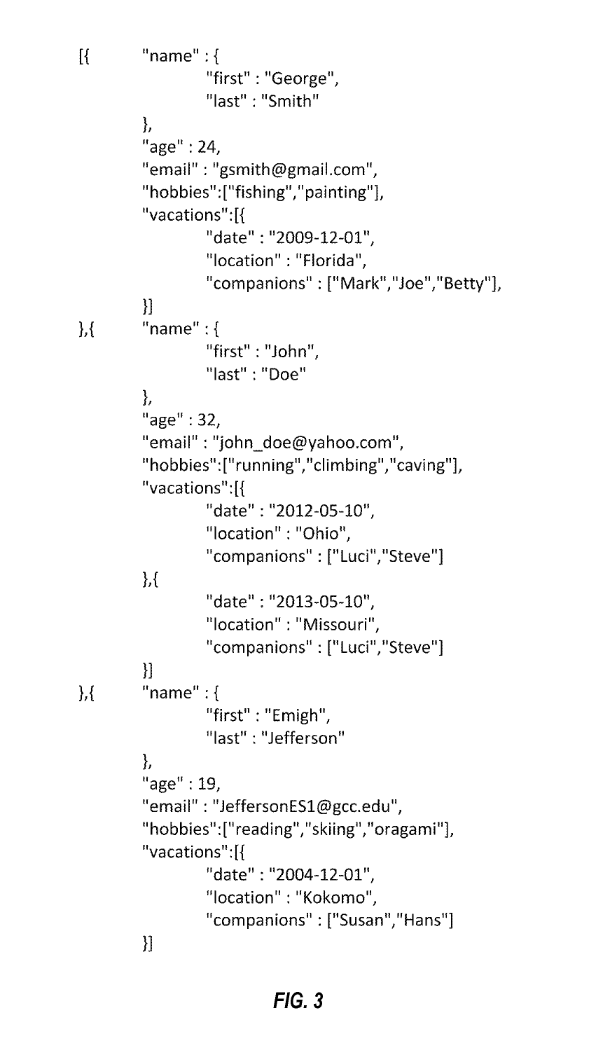

On the other hand, when the input module 110 receives data that comprises hierarchical information, the input module 110 can provide the data to the crawler module 120. Generally speaking, hierarchical data comprises datasets wherein an individual data field 210 or node 200 within the data set can comprise multiple data entries 230. For example, data stored within a tree structure—as exemplified in FIG. 2—can comprise hierarchical data. Similarly, data stored within a JSON (JavaScript Object Notation) file—as exemplified in FIG. 3—may also comprise hierarchical data.

While FIG. 1 depicts several independent modules 110, 120, 130, 140, 150, one will understand the characterization of a module is at least somewhat arbitrary. In at least one implementation, the modules 110, 120, 130, 140, 150 of FIG. 1 may be combined, divided, or excluded in configurations other than that which is shown. As used herein, the individual modules 110, 120, 130, 140, 150 are provided for the sake of clarity and explanation and are not intended to be limiting.

FIG. 2 depicts an embodiment of the present invention, wherein a crawler module 120 from FIG. 1 can analyze the data and extract appropriate information into individual flat data files 240, 245. The flat files generated from hierarchical data can comprise one flat file that acts as a master table 245 within a relational database, addressing each table and associated data entries so as to maintain the identity of the data fields and data entries with relation to one another. The flat files can be stored 250 in any of a variety of computer storage media.

As an example, the JSON file depicted in Figure represents a hierarchical data structure, which contains groups of ordered information stemming from a common point—or node. The groups of ordered information stemming from the node can comprise data fields further comprising data entries. For example, the JSON depicted in FIG. 3 contains information organized in a hierarchical structure about three individuals—George Smith, John Doe, and Emigh Jefferson. Referring to information associated with George Smith in FIG. 3, the group “vacations” can be a node within the JSON file. The “vacations” node is the common point from which the “companions” data field refers, and the “companions” data field further comprises the data entries “Mark,” “Joe,” and “Betty.” The stratification of information within the JSON file provides narrowed information from the category which it derives, and in this way, it can exemplify one possible hierarchical data structure.

Additionally, FIG. 3 can be viewed as having at least three nodes, one for each group of information associated with George Smith, John Doe, and Emigh Jefferson. “Hobbies” is an example of an independent data field associated with each of the aforementioned nodes. Within the “hobbies” data field, there are a varying number of data entries. For example, “fishing” and “painting” are data entries for the “hobbies” data field under the George Smith node, whereas “running,” “climbing,” and “caving” are data entries for the “hobbies” data field under the John Doe node.” In at least one embodiment, an independent data field comprises a unique group of data entries or a single data entry as seen in the previous example. The type of data entries associated with one independent data field can be can be represented in multiple data fields between separate nodes where one or more of the data entries is the same between different independent data fields of separate nodes. However, hierarchical data can include data sets with a plurality of configurations in addition to those exemplified in FIG. 3.

While the JSON file in FIG. 3 includes several examples of hierarchical data, one will understand the concepts of nodes and data fields is at least somewhat arbitrary. In at least one implementation, a node may also be a data field. As used herein, the notation of nodes and data fields are provided for the sake of clarity and explanation and are not intended to be limiting.

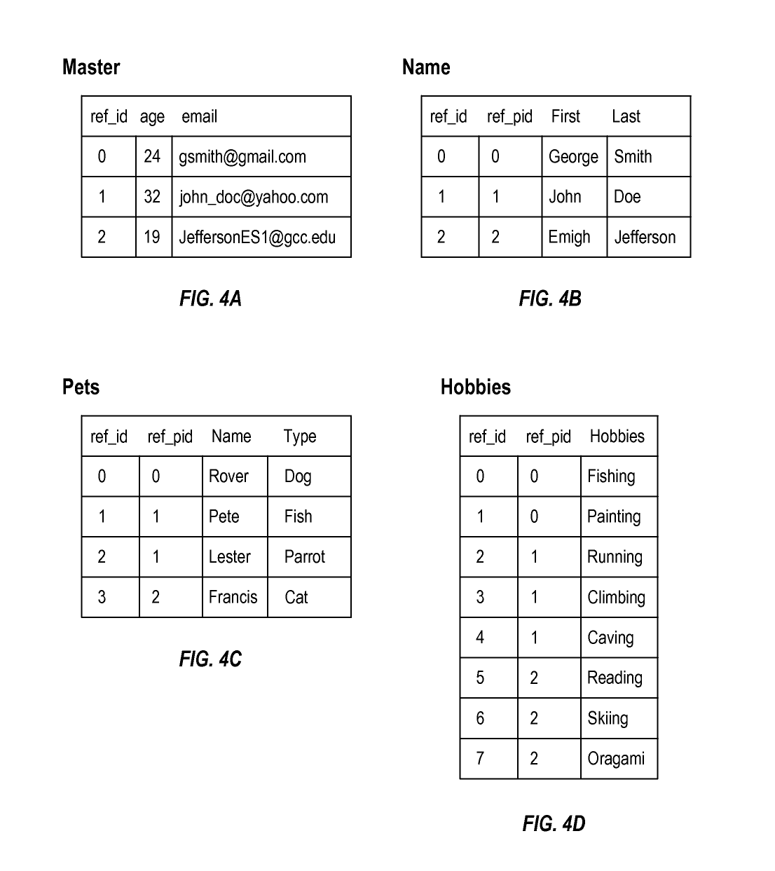

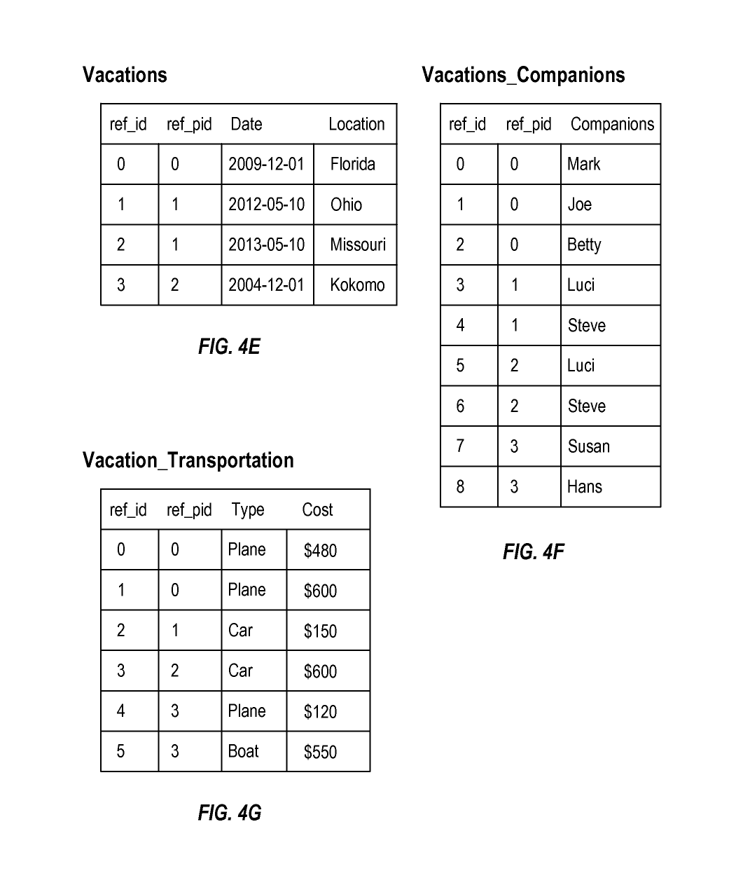

In at least one implementation, when analyzing the JSON file of FIG. 3, the crawler module 120 can first identify data fields that comprise only a single entry. For example, the data fields “age” and “email” both comprise only single entries. Once the crawler module 120 has identified data fields with only single entries, the crawler module 120 can create a master flat data table that comprises entries for each of these fields. For example, FIG. 4A depicts a master flat data table that comprises an age column and an email column, which contain the respective data entries for each of the individuals within the data set.

In contrast, when the crawler module 120 identifies data fields that comprise multiple entries, the crawler module 120 can generate new, separate flat data tables for each respective data field. For example, in FIG. 4, the data fields “hobbies,” “vacations,” “companions,” and “name” each comprise multiple entries. Upon identifying each of these respective data fields, the crawler module 120 can generate a new flat data table for each data field containing at least one data entry.

For instance, FIG. 4B depicts a data table for the data field “name.” In particular, the flat data table in FIG. 4B comprises a column for first names and a column for last names. Additionally, the flat data table of FIG. 4B comprises a ref_id column that comprises an address for each row within flat data table and a ref_pid that comprises an address for the parent of each respective row. For example, the row associated with the name “George Smith” comprises a ref_pid of “0,” which addresses the “0” row within the master table, and thus associates “George Smith” with the proper age and email.

Similarly, FIG. 4C depicts a flat data table that comprises the information from the “pets” data field. In addition, FIG. 4D is similar to FIG. 4C except that the table comprises information from the “hobbies” data field. Furthermore, FIG. 4E shows a flat data table comprising information from the “vacations” field. Further still, FIG. 4F shows a flat data table comprising information from the “vacations_companions” field. As a further example, the field “vacation_transportation” is comprised within a flat data table shown in FIG. 4G. Each of these flat data tables, as mentioned above, comprises reference IDs specific to each row within each respective flat data table and reference IDs that connect each row within each flat data table with the rows respective to the parent entry.

Accordingly, implementations of the present invention identify hierarchical data within a particular dataset and generate one or more individual flat data tables for the identified hierarchical data. Placing the data within multiple flat data tables may provide several advantages. For example, many database programs are structured to work with flat data. As such, implementations of the present invention can generate flat data tables that can be easily manipulated and processed using existing technologies and software applications.

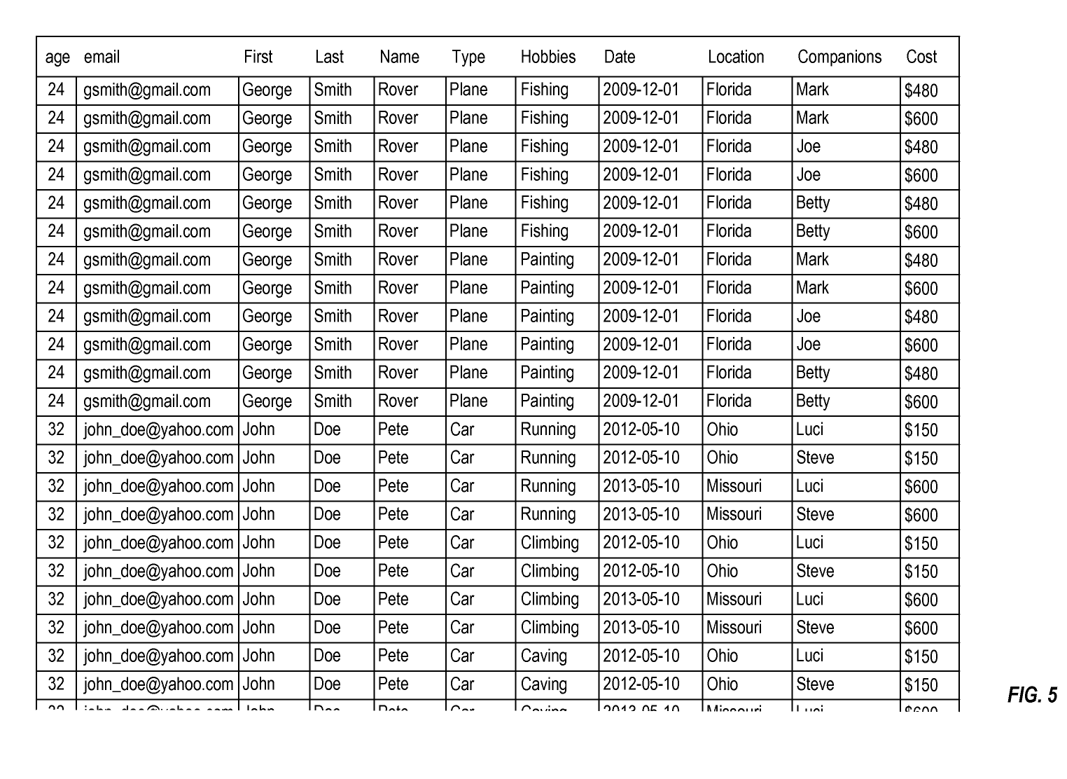

In at least one implementation of the present invention, the multiple flat data tables can be combined into a single cumulative flat data table. For example, FIG. 5 depicts a portion of a flat data table that comprises information from the multiple flat data tables depicted in FIGS. 4A-4G. As depicted, displaying hierarchical data within a single flat file can include displaying significant amounts of repeat data. For instance, the cumulative flat data table in FIG. 5 comprises multiple entries for the same age, email, first name, and last name.

While the cumulative flat data table depicted in FIG. 5 comprises the information stored within each of the multiple flat data tables in FIGS. 4A-4G, one will understand that the cumulative flat data table of FIG. 5 may require significantly more memory. Memory intensive databases not only consume large amounts of memory but are also much slower to analyze due to limited amounts of high speed memory. As such, storing, manipulating, and analyzing the data in the cumulative flat data table exemplified by FIG. 5 may be significantly slower and resource intensive than storing, manipulating, and analyzing the multiple flat data tables in FIGS. 4A-4G.

In at least one implementation of the present invention, the cumulative flat data table depicted in FIG. 5 can be stored in the multiple data tables, similar to those depicted in FIGS. 4A-4G. When the cumulative flat data table of FIG. 5 is requested, the smaller data tables of FIGS. 4A-4G can be quickly constituted into the table of FIG. 5. Accordingly, implementations of the present invention can provide the benefits of a cumulative flat data table, as depicted in FIG. 5, while maintaining the smaller memory space and ease of use benefits provided by the smaller individual tables of FIGS. 4A-4G.

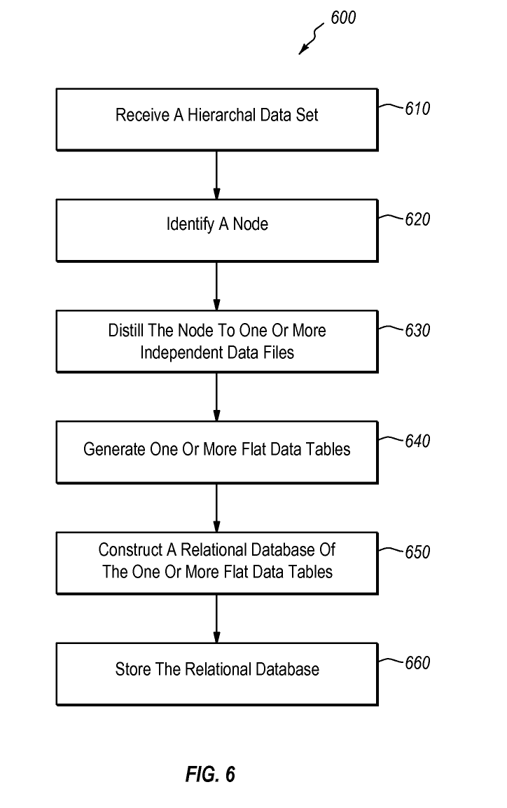

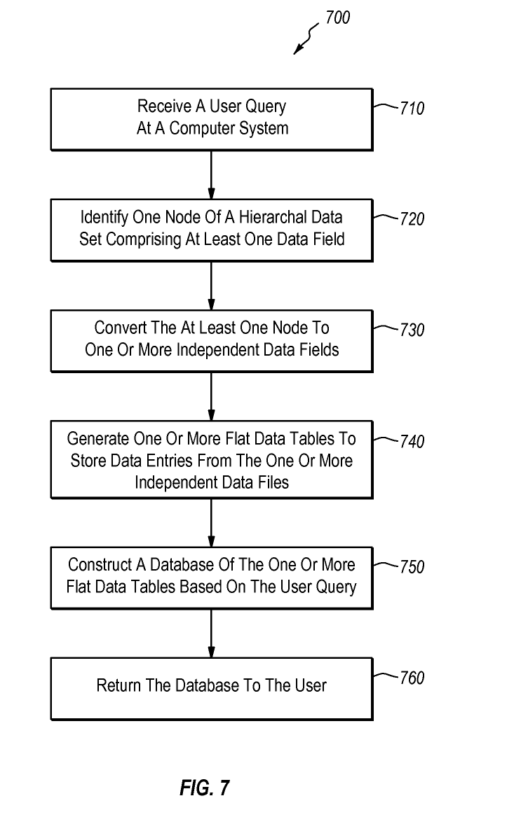

Accordingly, FIGS. 1-5 and the corresponding text illustrate or otherwise describe one or more components, modules, and/or mechanisms for automatically generating flat files from the hierarchically organized data files. One will appreciate that implementations of the present invention can also be described in terms of methods comprising one or more acts for accomplishing a particular result. For example, FIGS. 6 and 7, with the corresponding text, illustrates or otherwise describes a sequence of acts in a method for automatically generating flat files from the hierarchically organized data files. The acts of FIGS. 6 and 7 are described below with reference to the components and modules illustrated in FIGS. 1-4.

FIG. 6 shows that a method 600 for automatically converting hierarchical data to a flat database table can include an act 610 of receiving a hierarchical data set. Act 610 can comprise receiving a hierarchical data set comprising one or more nodes. For example, the Input Module 110 of FIG. 1 receives a data file from the Data Source Computer 101. As disclosed above regarding FIG. 1, the received data file can comprise one or more nodes that comprise at least one data field, which data field comprises more than a single data entry (e.g., a JSON file). Similarly, the received data file can comprise flat data received by the Input Module 110 and processed by the Flat Data Processor 140.

FIG. 6 shows that the method can also include act 620 of identifying a node. Act 620 can comprise identifying at least one node comprising at least one data field. In an embodiment of the present invention, a node can comprise at least one data field further comprising one or more data entries. For example, once the Input Module 110 receives the hierarchical data file, the Input Module 110 sends at least a portion of the data file to the Crawler Module 120 of FIG. 1. The Crawler Module 120 identifies a node within the hierarchically structured data file that includes at least one independent data field that comprises more than a single entry and sends at least a portion of the hierarchical data file to the Hierarchical Data Processor 130.

In addition, FIG. 6 shows that the method can include act 630 of distilling the node to one or more independent data fields. Act 630 can comprise distilling the at least one node to one or more independent data fields, wherein each of the one or more independent data fields comprise more than a single data entry. In an embodiment of the present invention, distilling a node to one or more independent data fields can include distinguishing data fields within the node, together with the associated data entries within each data field, so that each distinguished data field and associated data entries is distinct from each other distinguished data field and associated data entries within the node. For example, after the Crawler Module 120 identifies the node within the hierarchical data set, the Crawler Module 120 can distill the node to one or more data fields by identifying and distinguishing data fields within the node from each other identified data field within the node. The Crawler Module 120 can send at least a portion of the hierarchical data file to the Hierarchical Data Processor 130.

The notion of distilling the node to one or more data fields can be exemplified by FIGS. 3 and 4. Given the hierarchical data structure of the JSON file in FIG. 3, a Crawler Module 120 can identify a node within the hierarchical data set. For example, the Crawler Module 120 could identify the “vacations” node and distill the node by distinguishing the data fields “date” and “location.” The Crawler Module 120 can send the foregoing distilled information to the Hierarchical Data Processor 130, for incorporation into a flat data table. For example, the Hierarchical Data Processor 130 can incorporate the data fields “date” and “location” of the “vacations” node, together with the accompanying data entries, into a flat data table depicted in FIG. 4E.

Furthermore, FIG. 6 shows that the method can include act 640 of generating one or more flat data tables. Act 640 can comprise automatically generating one or more flat data tables to store data entries from the one or more independent data fields. For example, the Hierarchical Data Processor 130 generates flat data tables to store the data entries from the one or more independent data fields identified by the Crawler Module 120 in act 630.

In one embodiment of the present invention, act 640 can create a first table, which can comprise a master table for a relational database. For example, the Hierarchical Data Processor 130 of FIG. 1 can generate a first flat data table, which can comprise a master table 245 as exemplified in FIG. 2. In the same or another embodiment, the Hierarchical Data Processor 130 can generate a first flat data table comprising information stored within the at least one data field identified in act 630. For example, the system can perform an act (e.g., 630) of identifying at least one data field similar to object 221 in FIG. 2, wherein act 640 can generate table 240 of FIG. 2. Per act 640, the system can then generate a second or additional flat data tables. The second or additional flat data tables can comprise information stored within the at least one data field identified per act 630. For example, the Hierarchical Data Processor 130 can generate a second flat data table, as depicted in FIG. 4B. The generated flat data table of FIG. 4B comprises information that was stored within the “name” data field.

FIG. 6 shows that the method for generating multiple flat files from a hierarchical structure can include an act 640 of generating one or more flat data tables. Act 640 can include identifying data fields within the hierarchically organized nodes that comprise data entries that are compatible. For example, FIG. 3 depicts a JSON file that comprises nodes for George Smith, John Doe, and Emigh Jefferson. Upon reaching the data field “name” within the node for “John Doe,” the Hierarchical Data Processor 130 can identify that this particular data field is compatible with the data field “name” from the node “George Smith.” In at least one implementation, data fields are compatible if they comprise information of the same type. Act 640 can then include generating a table that contains compatible information.

The method of FIG. 6 can also include an act 650 of constructing a relational database of the one or more flat data tables. Act 650 can comprise constructing a relational database of the one or more flat data tables. For example, FIG. 2 illustrates the creation of a relational database 245 from table 240 generated from independent data field 221. The principle illustrated in FIG. 2 can be expanded to represent multiple independent data fields within the relational database, wherein the relational database serves to preserve the relationships exhibited in the original hierarchical data structure. For example, the master table in FIG. 4A correlates the ref_id “0” of the master table with the ref_pid “0” in other flat data tables. This allows the association of all information within the George Smith node of the hierarchical data file. The information includes, for example, his first and last name (FIG. 4B), the name and type of animal he has as a pet (FIG. 4C), and his hobbies of fishing and painting (FIG. 4D). The relational database created by act 650 provides a mechanism to link the information of disparate flat data tables generated by act 640 and preserve the structure of information provided by the hierarchical data source.

The method of FIG. 6 can also include act 660 of storing the relational database. For example, a relational database 245 depicted in FIG. 2 can be stored within any of a variety of storage media wherein the relationships exhibited in the original hierarchical structure can be preserved. In at least one embodiment of the present disclosure, storing the relational database can also allow the reconstruction of the hierarchical data and preserve the organizational structure and association of flat data tables generated in act 640.

FIG. 7 illustrates an additional or alternative computerized method in accordance with the present invention. In at least one particular implementation, the method of FIG. 7 can be performed by a computer system, comprising one or more processors; a system memory; and one or more computer-readable media storing computer-executable instructions that, when executed by the one or more processors, cause the computer system to implement a method (700) for converting a hierarchical data structure to a flat database table.

For example, FIG. 7 shows that this additional or alternative method can include an act 710 of receiving a user query at a computer system. Act 710 can comprise receiving a user query, wherein the user query causes a computer system to implement a method for converting a hierarchical data structure to a flat database table based on the user-specified query. For example, the Data Source Computer 101 of FIG. 1 can be a user computer wherein a user submits a query. In one embodiment of the present disclosure, the user query causes the computer system to implement a method including acts 720, 730, 740, 750, and 760 of FIG. 7.

FIG. 7 shows that the method can also include an act 720 of identifying one node of a hierarchical data set comprising at least one data field. Act 720 can comprise identifying at least one node of the hierarchical data comprising at least one data field. For example, the Input Module 110 of FIG. 1 can receive the user query and send information to the Crawler Module 120 to perform act 720 of identifying one node within the hierarchical data set comprising at least one data field in accordance with the specifications of the user query. In at least one implementation, the one node within the hierarchical data set comprising at least one data field can include a data field with at least one data entry. In one implementation, for example, the Crawler Module 120 can send at least a portion of the information to the Hierarchical Data Processor 130. In another implementation, the computer system can receive a user query, wherein act 720 can include identifying one node of hierarchical data comprising at least one data field, wherein the hierarchical data set is stored within computer storage media accessed by the computer system.

In addition, FIG. 7 shows that the method can include act 730 of converting the at least one node to one or more independent data fields. Act 730 can comprise converting the at least one node to one or more independent data fields, wherein each of the one or more independent data fields comprise more than a single data entry. For example, the Crawler Module 120 can analyze the at least one node to identify associated data fields and separate each of the data fields within the at least one node into distinct, independent data fields. The Hierarchical Data Processor 130 can extract the data entries from the independent data fields.

Further, FIG. 7 shows that the method can include act 740 of generating one or more flat data tables to store data entries from the one or more independent data fields. Act 740 can comprise automatically generating one or more flat data tables to store data entries from the one or more independent data fields. For example, the Hierarchical Data Processor 130 from act 730 can transfer the extracted data entries from the independent data fields to an automatically generated table for each set of data entries associated with each independent data field or compatible data fields.

FIG. 7 shows that the method can also include an act 750 of constructing a relational database of the one or more flat data tables generated in act 740. The relational database created by act 750 provides a mechanism to link the information of disparate flat data tables generated by act 740 and preserve the structure of information provided by the hierarchical data source.

In addition, FIG. 7 shows that the method can include an act 760 of returning the database to the user. For example, the Flat Data Processor 140 from FIG. 1 can return a user-defined database to the Data Source Computer 101, where the query may have originated. In an implementation of the present invention, the database generated by act 750 can be stored in addition to or instead of returning the database to the user. For example, the computer system could receive a user query based on a hierarchical data structure that has been previously converted to a relational database of flat files and stored in any of a variety of storage media accessible to the computer system. Act 750 can include constructing a database from the stored relational database according to the specifications of the user query. Additionally, Act 760 can include returning the constructed database to the user. As another example, act 760 can include returning the constructed database to a client computer 160 illustrated in FIG. 1. Returning the database to the user can comprise transmitting the database to a user computer and/or providing a user with an interaction prompt, wherein the interaction prompt allows the user to interact with the database that is stored on a remote server.

In an implementation of the present invention, a computer system can receive a user query in addition to a user-submitted hierarchical data set, wherein act 720 can include identifying one node of the user-submitted hierarchical data set comprising at least one data field. For example, acts 720, 730, and 740 can be reiterated until at least a portion of the user-submitted hierarchical data set has been converted into one or more flat data tables, wherein the one or more flat data tables can be compiled within a database that contains all of the information requested in the user query. The compiled database can then be returned to the client computer 160 according to act 760 or, alternatively, can be stored within any of a variety of computer storage media.

Accordingly, implementations of the present invention disclose methods and systems for automatically generating flat data tables from the hierarchically organized data files. In particular, implementations of the present invention allow a hierarchically organized data set to be efficiently stored and processed within a flat data table database. In an embodiment of the present invention, a user query can drive the parameters used in generating a flat data table from a hierarchical data source. A database can be compiled from the flat data tables in accordance with the specifications of the user query and returned to the client computer 160 or, alternatively, stored within any of a variety of computer storage media. Additionally, implementations of the present invention provide methods for quickly reconstituting a complete hierarchical data set within a single flat data table.

Further, in at least one implementation of the present invention, reconstituting a complete hierarchical data set within a single flat data table allows several different commonly used database functions to be applied to the data. For example, MySQL can perform various methods (e.g., join/views), which allows the data to be observed, queried, and analyzed using standard database commands. In at least one implementation, the methods can be performed as though the data is stored as depicted in FIG. 5, while the actual data itself can be stored as depicted in FIGS. 4A-4G. As such, various implementations of the present invention, allow standard database commands to be used on a hierarchical dataset, while conversing significant memory space by storing the dataset within multiple flat data tables, as depicted in FIGS. 4A-4G.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. At a server computer system in a computerized environment in which one or more users manage data, a computerized method for automatically converting hierarchical data to a flat database table, the method comprising:
receiving a hierarchical data set comprising one or more nodes;
identifying at least one node comprising at least one data field;
distilling the at least one node to one or more independent data fields, wherein each of the one or more independent data fields comprise more than a single data entry;
automatically generating one or more flat data tables to store data entries from the one or more independent data fields; and
constructing a relational database of the one or more flat data tables; and
storing the relational database.

2. The method in claim 1, wherein other one or more data fields that comprise at least a single data entry are automatically stored in a single automatically generated flat data table.

3. The method in claim 2, wherein the single automatically generated flat data table comprises the master table for the relational database.

4. The method in claim 1, wherein the at least one node comprises a single data field.

5. The method in claim 1, wherein at least one of the automatically generated flat data tables stores data entries from the one or more data fields that comprise a single data entry.

6. The method in claim 1, wherein one or more nodes comprise at least a single data entry.

7. The method as recited in claim 1, wherein a data field comprises a data entry selected from a group consisting of an object, an array of objects, a single value, an array of values, and an object itself.

8. The method as recited in claim 1, further comprising generating a single flat data table that comprises each of the data fields within the hierarchical data set.

9. The method as recited in claim 8, wherein one or more of each of the data fields appears multiple times within the single flat data table.

10. The method as recited in claim 1, wherein receiving the data set comprises receiving the data set from an application programming interface.

11. The method as recited in claim 1, wherein each of the one or more flat data tables comprises only a portion of the data fields from the hierarchical data sets.

12. The method as recited in claim 11, wherein each of the data fields from the hierarchical data sets appears at least once within the one or more flat data tables.

13. The method as recited in claim 1, wherein storage of the relational database occurs on random-access memory (RAM).

14. A computer system, comprising:
one or more processors;
system memory; and
one or more computer-readable media storing computer-executable instructions that, when executed by the one or more processors, cause the computer system to implement a method for converting a hierarchical data structure to one or more flat database tables, the method comprising:
receiving a user query, wherein the user query causes a computer system to:
identify at least one node of the hierarchical data structure comprising at least one data field,
convert the at least one node to one or more independent data fields, wherein each of the one or more independent data fields comprise more than a single data entry,
automatically generate one or more flat data tables configured to store data entries from the one or more independent data fields,
construct a database of the one or more flat data tables based on the user query, and
return the database to the user.

15. The system recited in claim 14, wherein the constructed database comprises only a portion of the data entries from the one or more flat data tables.

16. The system recited in independent claim 14, wherein the constructed database comprises a relational database.

17. The system recited in independent claim 14, wherein each of the one or more flat data tables comprises only a portion of the data fields from the hierarchical data structure.

18. The system recited in independent claim 17, wherein each of the data fields from the hierarchical data structure appears at least once within the one or more flat data tables.

19. The method as recited in claim 14, further comprising generating a single flat data table that comprises each of the data fields within the hierarchical data structure.

20. A computer program product comprising one or more recordable-type computer-readable storage devices having stored thereon computer-executable instructions that, when executed by one or more processors of a computer system, cause the computer system to execute a method for automatically converting hierarchical data to a flat database format, the method comprising:
receiving a hierarchical data set comprising one or more nodes;
identifying at least one node comprising at least one data field;
distilling the at least one node to one or more independent data fields, wherein each of the one or more independent data fields comprise more than a single data entry;
automatically generating one or more flat data tables to store data entries from the one or more independent data field; and
constructing a relational database of the one or more flat data tables; and
storing the relational database.
